(19) United States
(12) Patent Application Publication
(10) Pub. No.: US 2019/0101957 A1
(43) Pub. Date: Apr. 4, 2019

(54) Cell Tablet

(71) Applicant: Scott Alexander, Chicago, IL (US)

(72) Inventor: Scott Alexander, Chicago, IL (US)

(21) Appl. No.: 16/152,387

(22) Filed: Oct. 4, 2018

Related U.S. Application Data
(60) Provisional application No. 62/568,120, filed on Oct. 4, 2017.

(51) Int. Cl. G06F 1/16

(52) U.S. Cl. CPC G06F 1/1647; G06F 1/1681; G06F 1/1624

(57) ABSTRACT

A cell tablet comprising three screens which are capable of being stacked or collapsed to form a device approximately the size of a smartphone; or extended to form a device approximately the size of a tablet.

### CLAIM OF PRIORITY

This patent application claims priority under 35 USC 119 (e) (1) from U.S. Provisional Patent Application Ser. No. 62/568,120 filed Oct. 4, 2017, of common inventorship and title herewith which is incorporated herein by reference as though the same were set forth in its entirety.

### FIELD OF THE INVENTION

The present invention pertains to the field of cell phones and tablets, and more specifically to the field of cell phones and tablets with a cellular smartphone and tablet computer creatively combined into one convenient unit.

### BACKGROUND OF THE INVENTION

One the most explosive new technologies to come out of the last twenty years is the cellular telephone. In 1994, 16 million Americans were subscribers to cellular phone services. By 2002, that number had ballooned to more than 110 million. In fact, some experts predict that worldwide subscribership will reach 1.5 billion people by the end of 2016. The basic concept of cellular phones began in 1947, when AT&T researchers sought ways to increase the traffic capacity and frequency of mobile communication in police car radios. However, nonexistent technology and stringent FCC regulations postponed availability until 1982, when the FCC authorized commercial cellular use. As a result of this regulation, the scientific advances of the intervening years and increased competition among communications companies put the cellular telephone on the fast track. Today's widespread use of these revolutionary devices is unsurprising, since they now offer a virtually endless array of benefits. In addition to serving as a practical means of communication while on the go, technological advances have evolved cell phones into mini computers. Capable of keeping consumers abreast of the latest stock quotes, providing wireless Internet access, capturing photos and videos, enabling social networking, and playing music and games, in addition to many other features, cellular and digital telephones have become practically indispensable to millions the world over.

Another revolutionary device to invade the world is the tablet computer. According to PC Magazine, a tablet computer is a complete personal mobile computer, larger than a mobile phone or personal digital assistant, integrated into a flat touch screen and primarily operated by touching the screen. It often uses an onscreen virtual keyboard or a digital pen rather than a physical keyboard. Because of these features, the tablet computer can essentially perform all the functions of a laptop computer, albeit with a lighter weight, easier user interface, and considerably shorter boot-up period, all of which are essential for the constant demands of on-the-go living. Apple's iPad has perhaps become synonymous with the tablet computer; the device has moved nearly 250 million units worldwide since its launch in April 2010, and shows no signs of slowing down.

The prior art has put forth several designs for cell phones and tablets. Among these are:

U.S. Pat. No. 6,850,780 to Rich Gioscia provides a compact personal digital assistant (PDA) and cellular telephone with foldable dual-sided display. By utilizing flexible display technology, both a PDA and a cellular telephone are incorporated into one device. In a closed state, the present invention corresponds to the form used for typical cellular telephone use (e.g., candy bar size). In an open state, in one embodiment, the present invention corresponds to the form used for typical PDA use by providing an enlarged viewing area.

U.S. Pat. No. 7,782,274 to Gregory P. Manning provides various configurations of an electronic display, and devices incorporating the display. The display may have multiple portions connected along one or more axes, lines, points, or other connecting areas. The portions are movable about the connections. In various configurations, the display portions emulate different media and/or communication and computing devices. Two or more of the display devices may be coupled in an array.

U.S. Pat. No. 7,180,665 to Simon R. Daniel provides a display device having an extendible screen and at least one extendible side member. The extendible screen is extendible in an extension direction from a relatively compact form to an extended form. The screen in the extended form has opposed edges that are substantially parallel to the extension direction. An extendible side member is provided for at least one of said opposed edges. Each extendible side member is extendible to provide support to and structural rigidity to the screen when the screen is in the extended form. The display device provides an extendible rigid screen suitable for example for creating a rigid collapsible tablet computer, or enabling a compact portable display to support a rigid touch-screen, or for incorporation into a mobile phone or remote control unit.

None of these prior art references describe the present invention.

### SUMMARY OF THE INVENTION

It is an object of the present invention to provide a cellular smartphone and tablet computer creatively combined into one convenient unit.

### BRIEF DESCRIPTION OF THE DRAWINGS

FIG. 1 is a perspective view illustrating the Cell Tablet, constructed in accordance with the present invention, prior to extension, collapsed to the approximate size of a smartphone.

FIG. 2 is a perspective view illustrating the Cell Tablet, constructed in accordance with the present invention, after extension, extended to the approximate size of a tablet.

FIG. 3 is a perspective view of the Cell Tablet of the present invention showing the screens being extended, before they are raised to make a flat tablet surface.

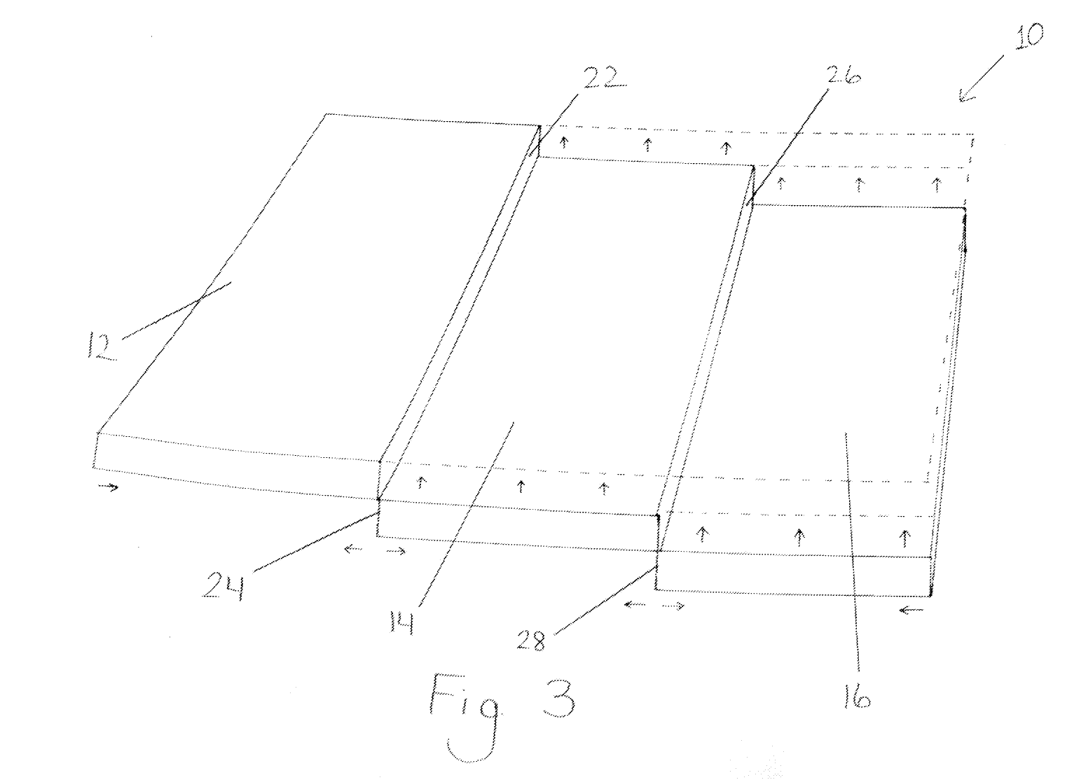

### DETAILED DESCRIPTION OF THE INVENTION

Please refer to the drawings. The present invention is a Cell Tablet 10 comprising a cellular smartphone and tablet computer creatively combined into one convenient unit. In this manner, users are be able to enjoy all of the attributes of both without having to purchase separate devices. While standard smartphones already perform essentially the same features as tablets, the concept behind the Cell Tablet is to offer one simple unit that can expand, or retract, into either device. To achieve this, the Cell Tablet, comprises three screens which are capable of being collapsed and extended. Each screen has a first side and a second side. The three screens are referred to as first screen, or main screen 12; second screen 14; and third screen 16.

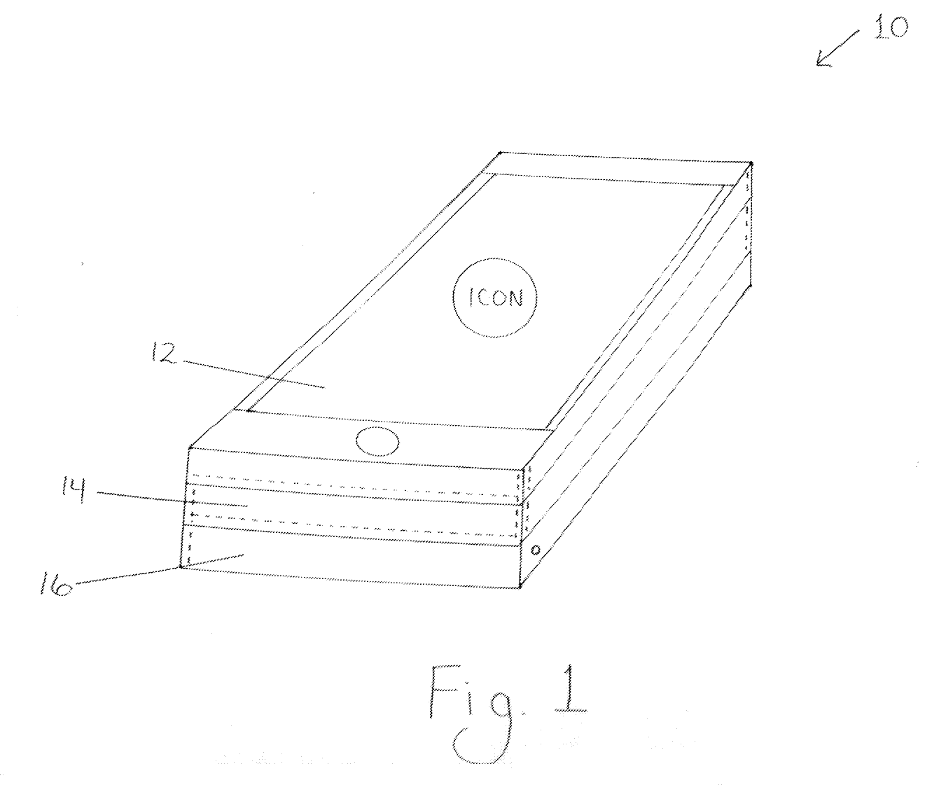

When the three screens are stacked or collapsed, the main screen 12 is on top, the second screen 14 is directly underneath the main screen and the third screen 16 is directly underneath the second screen. The resulting device is approximately the size of a smartphone. This configuration is shown in FIG. 1.

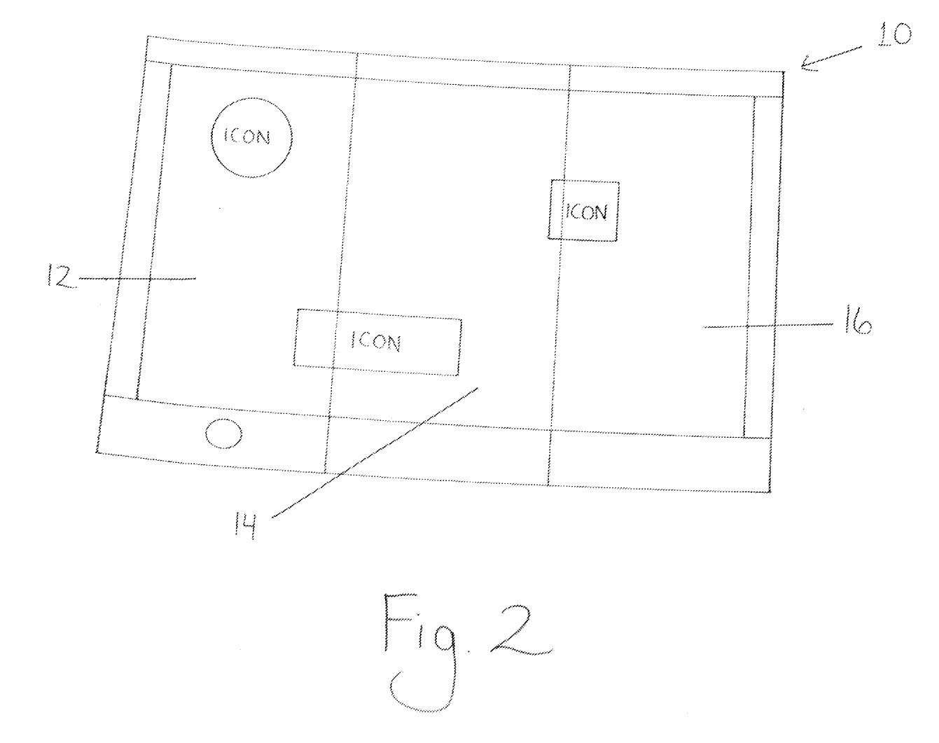

When the three screens are extended, the second screen 14 and third screen 16 are pulled away from and raised to the same level of the main screen 12 in a side by side configuration so the edges of the screens abut one another to its extended state, resulting in a device about the size of a tablet. In an embodiment, the main screen 12 is abutted on the second side 22 by the first side 24 of the second screen 14 and the second screen 14 is abutted on its second side 26 by the first side of the third screen 28. In this configuration the second screen 14 and third screen 16 are pulled away from the main screen, so that the third screen 16 is connected to the second screen 14 and the main screen 12 is also connected to the second screen 14. This is the configuration shown in FIG. 2. In this configuration, the main screen is on one side.

Alternatively, the second screen 14 is pulled away from and abuts the main 12 screen from the first side 24 and the third screen 16 is pulled away from the main screen 12 and abuts the second side 22 of the main screen 12. In this configuration, the main screen 12 remains in the center of the three screens.

In an embodiment, it is contemplated that the abutting edges of the screens are capable of communicating with each other to form a single image on the extended screen.

The screens are in movable communication with each other by means of any suitable sliding hinge. Sliding hinges suitable for use in the present invention are described in U.S. Pat. No. 7,779,509, US Patent Publication 2011/01678939, and World Patent Application WO2012/133958.

When a user wishes to use the device as a tablet, the user pulls the second and third screen from under the main screen of the smartphone, whereby the available screen area of the tablet configuration is instantly tripled in size from the screen area provided by the collapsed configuration. Should the device ring to announce an incoming phone call when one is searching the internet via the extended screens, the user need only replace the extra screens, accept the call, and place the compacted device to the ear. Alternately, the phone call could be answered on speaker, with the unit remaining in the tablet configuration.

The Cell Tablet of the present invention is a creative concept that offers a number of benefits and advantages. Foremost, the Cell Tablet combines into one unit two of the most popular consumer electronics items, the cell phone and the tablet computer. Outfitting a phone-sized device with additional collapsible screens, the Cell Tablet provides an instant tablet that can easily be carried in the pocket. Fully functional as a telephone, the Cell Tablet is always at the ready to accommodate any communications needs. The 2-in-1 concept of the Cell Tablet eliminates the need to own as well as try to carry separate devices, allowing users to stay up to date on technology without unnecessary expenditure of resources.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An electronic device combining a cellular smartphone and tablet computer comprising:
three screens which are capable of being collapsed and extended wherein the three screens comprise:
a main screen having a first side and a second side and;
second screen having a first side and a second side; and
a third screen having a first side and a second side; wherein the main screen is connected to the second screen by means of a first sliding hinge, and the second screen is connected to the third screen by means of a second sliding hinge; wherein the first sliding hinge allows the second screen to be extended and raised to the same level as the main screen and the second sliding hinge allows the third screen to be extended and raised to the same level as the main screen and the second screen; further wherein the first side of the second screen abuts the second side of the main screen; and further wherein the first side of the third screen abuts the second side of the second screen.

2. The electronic device of claim 1 wherein the three screens are capable of being stacked or collapsed wherein the main screen is on top, the second screen is directly underneath the main screen and the third screen is directly underneath the second screen, resulting in a device approximately the size of a smartphone.

3. The electronic device of claim 1, wherein the three screens are capable of being extended, the main screen is abutted on its second side by the first side of the second screen and the second screen is abutted on its second side by the first side of the third screen, resulting in an extended screen device about the size of a tablet.

4. The electronic device of claim 3, wherein the screens are capable of communicating with each other to form a single image on the extended screen.

5. The electronic device of claim 1, wherein the screens are in movable communication with each other by means of a sliding hinge

6. The electronic device of claim 2, wherein the screens are in movable communication with each other by means of a sliding hinge.

7. The electronic device of claim 3, wherein the screens are in movable communication with each other by means of a sliding hinge.

8. The electronic device of claim 4, wherein the screens are in movable communication with each other by means of a sliding hinge.
